(19) United States
(12) Patent Application Publication
(10) Pub. No.: US 2008/0317191 A1
(43) Pub. Date: Dec. 25, 2008

(54) OPERATING METHOD OF NUCLEAR REACTOR AND NUCLEAR POWER GENERATION PLANT

(76) Inventors: Masao Chaki, Hitachi (JP); Motoo Aoyama, Mito (JP); Tetsushi Hino, Hitachi (JP); Kazuya Ishii, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/765,486

(22) Filed: Jun. 20, 2007

(51) Int. Cl. G21C 7/32

(52) U.S. Cl. 376/210

(57) ABSTRACT

The present invention decreases the temperature of feed water supplied to the reactor of a set power when the flow rate of coolant supplied to the core of the reactor increases in the end of an operation cycle. This operating method can increase the thermal power of the nuclear power generation plant and increase the economical efficiency of fuel even when the operation cycle is prolonged. Particularly, even when the core flow rate increases in the end of the operation cycle, this method can suppress the rise of the cooling water temperature at the inlet of the core. Consequently, this invention can make the reactivity gain higher than that when the core flow rate is singly increased.

The present invention can increase the thermal power of a nuclear reactor, and can improve the economical efficiency of fuel even when a period of an operation cycle is made longer.

### BACKGROUND OF THE INVENTION

The present invention relates to a operating method of a nuclear reactor and a nuclear power generation plant, and more particularly, to a operating method of a nuclear reactor ideally applicable to up-rated nuclear reactors and to be fit for long operation period.

To increase the power generation capacitance of a nuclear power generation plant and run the plant for a long operation period, it is general to increase the mean enrichment of ²³⁵U in fuel assemblies that are loaded in the core. Further, for making up for reactivity, it is general, in the end of an operation cycle, to increase the core flow rate, reduce the volume fraction (void fraction) of steam in the core, and promote moderation of neutrons. As one of technologies to vary the void fraction in the core to control the reactivity, there is a feed water temperature control that varies the temperature of feed water and consequently controls the temperature of cooling water at the inlet of the core. The technologies for controlling the reactivity by the feed water temperature control are disclosed by Japanese Patend Laid-open No. Hei 8(1996)-233989 and Japanese Patend Laid-open No. Sho (1987)-138794.

### SUMMARY OF THE INVENTION

However, the above technology has a problem that, when the power generation capacitance and the mean enrichment of fuel assemblies are increased for long operation period, the capacity factor of the nuclear power generation plant increases but generally the economical efficiency of fuel reduces. Furthermore, when the core flow rate is increased to make up for the reactivity, the existing reactor does not control the temperature of feed water and the flow rate of feed water is determined in proportion to the power of the nuclear power generation plant, namely the flow rate of main steam. Therefore, the technologies have the following problems. If the thermal power remains unchanged when the core flow rate is increased, the flow rate and temperature of feed water do not change notably and the ratio of flow rate of colder feed water to the core flow rate goes down by the increment of the core flow rate. Therefore, the temperature of cooling water at the inlet of the core increases in comparison with the temperature of cooling water before the core flow rate is increased and this decreases the effect of reducing the void fraction due to increase of the core flow rate. Still further, the conventional technology for controlling the reactivity by changing the temperature of feed water decides only a control logic outline such as first stage, middle stage, and last stage and contains no description pertaining to variation of the core flow rate.

An object of the present invention is to provide a operating method of a nuclear reactor and a nuclear power generation plant which can increase the thermal power of a nuclear reactor, and can improve the economical efficiency of fuel even when a period of an operation cycle is made longer.

The present invention to accomplish the above object is characterized by reducing the temperature of feed water being supplied to a nuclear reactor when the flow rate of coolant fed to the core of the reactor, which is operated at set power in one operation cycle, increases.

According to the present invention, the thermal power is increased, and the economical efficiency of fuel of a nuclear power generation plant can be improved even when the period of the operation cycle is made longer. Particularly, even when the core flow rate is increased at the end of the operation cycle, the present invention can suppress the increase of coolant temperature at the inlet of the core and further increase the reactivity gain when the core flow rate is increased at the end of the operation cycle more than that when the core flow rate is singly increased.

Another characteristic of the present invention to accomplish the above object is to contain
a feed water heating apparatus,
a feed water system for supplying the feed water to the reactor, and
a feed water temperature control apparatus that reduces the temperature of feed water by controlling the heating rate of feed water by the feed water heating apparatus when the flow rate of coolant supplied to the core is increased.

Still another characteristic of the present invention to accomplish the above object is to contain
a feed water heating apparatus,
a feed water system for supplying the feed water to the reactor,
a heat balance calculation apparatus for calculating a set temperature of feed water based on calculating the heat balance using thermal energy that is generated in the reactor, thermal energy that goes out from the reactor, and heat that comes into the reactor from the outside when the flow rate of coolant fed to the core in the reactor increases, and
a feed water temperature control apparatus for controlling the heating of the feed water by the feed water heating apparatus based on the set feed water temperature calculated by the heat balance calculation apparatus.

According to the present invention, the thermal power is increased, and the economical efficiency of fuel of a nuclear power generation plant can be improved even when the period of the operation cycle is made longer.

### BRIEF DESCRIPTION OF THE PREFERRED DRAWINGS

FIG. 1 is a structural diagram showing a boiling water type nuclear power generation plant according to a preferred embodiment of the present invention.

FIG. 2 is characteristic diagram showing changes in core flow rate and coolant temperature at core inlet in an operation cycle of a reactor.

FIG. 3 is an explanatory drawing showing arithmetic operation of the heat balance calculation apparatus and control operation of the feed water temperature control apparatus of FIG. 1.

FIG. 4 is a structural diagram showing a boiling water type nuclear power generation plant according to another embodiment of the present invention.

FIG. 5 is characteristic diagram showing changes in core flow rate and coolant temperature at core inlet in an operation cycle of a reactor which is used by another embodiment of the present invention.

### DETAILED DESCRIPTION OF THE PREFERRED EMBODIMENTS

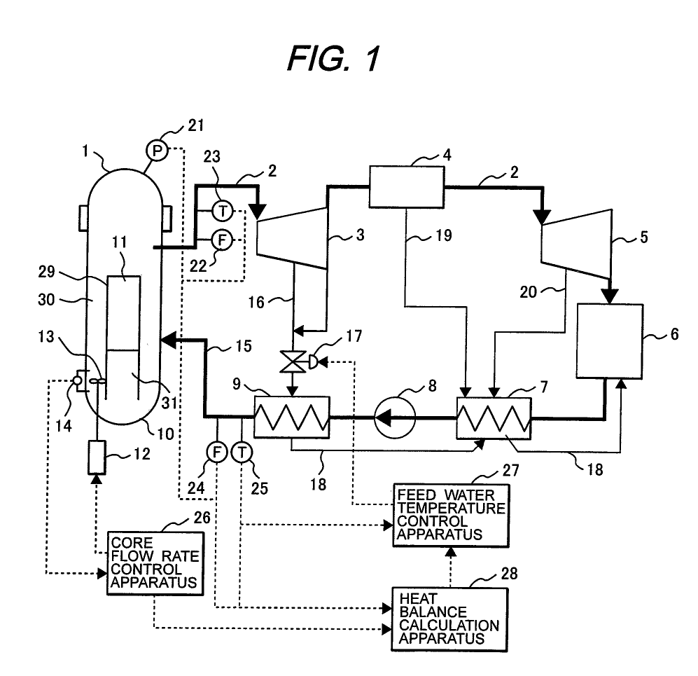

Referring to FIG. 1, a boiling water type nuclear power generation plant will be explained below as a nuclear power generation plant which is a preferred embodiment of the present invention.

A boiling water type nuclear power generation plant is equipped with a reactor 1, high pressure turbine 3, low pressure turbine 5, and a condenser 6. The reactor 1 contains core 11 loading a plurality of fuel assemblies (not shown in the figure) in a reactor pressure vessel 10. A cylindrical core shroud 29 surrounds core 11 in the reactor pressure vessel 10. Internal pumps 12 is provided beneath the reactor pressure vessel 10. Each impeller 13 of the internal pumps 12 is placed in an annular space 30 (used as a liquid channel) formed between the reactor pressure vessel 10 and the core shroud 29. Differential pressure gauge 14 is arranged in the annular space 30 to measure the difference between upstream and downstream pressures of the impeller 13. Main steam pipe 2 connected to the reactor pressure vessel 10 connects the high pressure turbine 3, a moisture separate super heater 4 (or moisture separate re-heater) and the low pressure turbine 5. The high pressure turbine 3 and the low pressure turbine 5 are connected to a power generator (not shown in the figure). A feed water pipe 15 connects the condenser 6, low pressure feed water heater 7, feed water pump 8, high pressure feed water heater 9 and the reactor pressure vessel 10 in that order. An extraction pipe 16 connected to the high pressure turbine 3 is connected to the high pressure feed water heater 9. Pipe 19 connected to the moisture separate super heater 4 and pipe 20 connected to the low pressure turbine 5 are respectively connected to the low pressure feed water heater 7. A steam flow rate controlling valve 17 is provided in the extraction pipe 16. A drain pipe 18 connected to the high pressure feed water heater 9 is connected to the condenser 6 via the low pressure feed water heater 7.

A pressure gauge 21 is placed an upper portion of the reactor pressure vessel 10 to detect the (steam) pressure in the reactor pressure vessel 10. A flow meter 22 to detect steam flow rate and a thermometer 23 to detect steam temperature are provided to the main steam pipe 2. A flow meter 24 to detect feed water flow rate and a thermometer 25 to detect feed water temperature are provided to the feed water pipe 15.

The nuclear power generation plant is further equipped with core flow rate control apparatus 26, feed water temperature control apparatus 27, and heat balance calculation apparatus 28.

During the operation of the nuclear power generation plant, cooling water (coolant) in annular space 30 is pressurized by the impeller 13 of the internal pump 12 rotated and supplied into core 11 through the plenum 31 under the core 11. The cooling water is further supplied to fuel assemblies loaded in core 11 and heated by nuclear fission of nuclear fuel materials. Part of the cooling water comes to a boil by the heating. Generated steam is introduced to a steam separator (not shown) and a steam dryer (not shown) that are provided above core 11 in the reactor pressure vessel 10 to remove moisture and then exhausted to the main steam pipe 2. The steam causes the high pressure turbine 3 to rotate. The steam is moisture-removed moisture and super-heated by the moisture separate super heater 4. The super-heated steam is supplied to the low pressure turbine 5 and rotates the turbine. Rotations of the high pressure turbine 3 and the low pressure turbine 5 cause the power generator (not shown) to rotate and generate electric power. The steam exhausted from the low pressure turbine 5 is condensed into water by the condenser 6. The condensate is introduced as feed water to the reactor pressure vessel 10 through the feed water pipe 15. The feed water is heated by the low-pressure feed water heater 7, pressurized by the feed water pump 8, heated further by the high pressure feed water heater 9, and supplied into the reactor pressure vessel 10. The low pressure feed water heater 7 heats the feed water by high temperature water drained from the moisture separate super heater 4, and steam and condensed water extracted from the low pressure turbine 5 through pipes 19 and 20. The high pressure feed water heater 9 heats the feed water exhausted from the low pressure feed water heater 7 by the steam extracted from the high pressure turbine 3 and introduced by the extraction pipe 16.

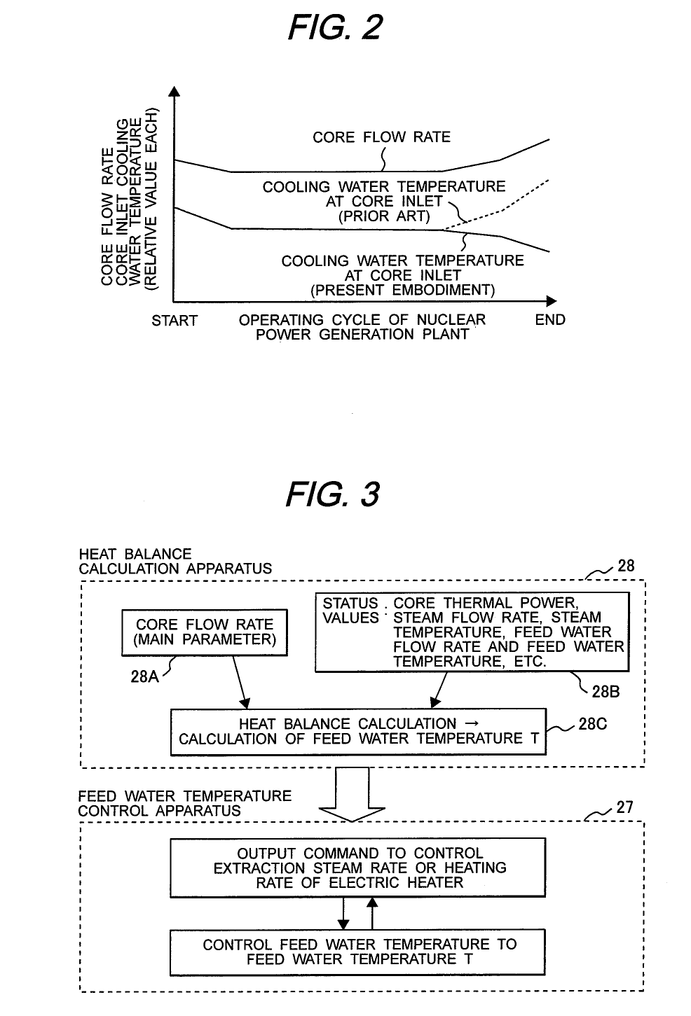

The present embodiment is characterized in that the reactivity is increased by controlling feed water temperature in the end of an operation cycle of the reactor and consequently the reactor power is increased. One operation cycle means a time period between the start of operation of reactor 1 and the shutdown of the reactor 1 to exchange the fuel assemblies loaded in the core 11. With reference now to FIG. 2, the outline of increasing the reactivity of a reactor by control of feed water temperature will be explained below.

Referring to FIG. 2, we explain how the core flow rate and the temperature of cooling water at the core inlet behave in each of the present embodiment, and a conventional embodiment that does not control temperature of feed water during one operation cycle. In the conventional embodiment that does not perform feed water temperature control, the temperature of cooling water at the inlet of the core changes according to the core flow rate during an operating cycle. When the reactor power is constant, the flow rate of the feed water is also constant and the feed water temperature changes very little. At the same time, the flow rate of the steam discharged from reactor 1 to the main steam pipe 2 is basically constant. Further the feed water is basically a condensate of main steam condensed by the condenser 6. Therefore, the flow rate of feed water is basically constant unless the flow rate of main steam varies. The low temperature condensate exhausted from the condenser 6 is heated by the feed water heaters 7 and 9. In the existing boiling water type nuclear power generation plant, however, it is general that the plant does not dynamically control the feed water heating rate unless otherwise required and use the initial set heating rate. In other words, the existing boiling water type nuclear power generation plant is not equipped with a mechanism to dynamically control the feed water temperature. Therefore, in the existing boiling water type nuclear power generation plant, the feed water flow rate and feed water temperature will not vary unless the reactor power changes.

Contrarily, in the boiling water reactor, the core flow rate controls the reactivity of the core according to change of void fraction in the core. Therefore, the core flow rate is changed appropriately during one operation cycle. In reactor pressure vessel 10, the cooling water circulates in the order of the core 2, the annular space 30, the lower plenum 31, and back to the core 2. If the core flow rate changes, the flow rate of the re-circulation cooling water of saturation temperature also changes. In the existing boiling water type nuclear power generation plant in which feed water temperature and feed water flow rate are constant, the temperature of the cooling water at the core inlet rises when the core flow rate increases and the temperature of the cooling water decreases when the core flow rate decreases as shown in FIG. 2. When the core inlet temperature varies along with the change of the core flow rate in this way, particularly when the core flow rate is increased to make up for the reactivity of core 2 in the end of an operation cycle, the temperature of the cooling water at the inlet of the core rises before the core flow rate increases, and a problem that the effect of the reduction of void fraction in the core due to the increase of the core flow rate becomes less occurs. To solve this problem, the present embodiment dynamically controls the heating rate of the feed water so as to reduce the temperature of the cooling water at the inlet of the core (inversely with the conventional embodiment) when the core flow rate increases in the end of the operation cycle. By this control, the present embodiment can suppress the rise of the cooling water temperature at the inlet of the core even when the core flow rate increases in the end of the operation cycle.

Further the present embodiment can make the reactivity gain when the core flow rate goes up at the end of the operating cycle greater than that when the core flow rate is singly increased. Therefore, the present embodiment can improve the economical efficiency of fuel as long as the operating period is identical. Substantially, the present embodiment can reduce the mean enrichment of fuel assemblies that are loaded in core 2. Further, when the identical economical efficiency of fuel is kept, the operating period of the boiling water type nuclear power generation plant can be made longer. This can increases the thermal power of the nuclear power plant and increase the capacity factor of the boiling water type nuclear power generation plant also when the operation cycle is made longer. In other words, this can increase the economical efficiency of the plant.

To reduce the temperature of cooling water at the inlet of the core when the core flow rate is increased in the end of the operation cycle, namely to reduce the temperature of water supplied to the reactor 1, the present embodiment is equipped with the heat balance calculation apparatus 28 and the feed water temperature control apparatus 27 that controls the degree of the opening of the steam flow rate controlling valve 17 according to the feed water temperature obtained by heat balance calculation apparatus 28. Feed water temperature control of the present embodiment will be explained below referring to FIG. 1 and FIG. 3.

The core flow rate control apparatus 26 inputs the difference between upstream pressure and downstream pressures of impeller 13 in the annular space 30 that are measured by differential pressure gauge 14 and calculates the core flow rate based on the measured pressure difference. The core flow rate control apparatus 26 controls the rotational speed of internal pump 12 according to the calculated core flow rate and the rated core flow rate during the operation cycle. That is, the flow rate (core flow rate) of cooling water supplied to core 11 is controlled by the core flow rate control apparatus 26.

The heat balance calculation apparatus 28 calculates the energy balance, by using only the core flow rate as a parameter, based on thermal energy that is generated in core 2, heat that goes out from reactor 1 (mainly as main steam), and thermal energy that comes into reactor 1 from the outside (mainly as feed water). Substantially, the heat balance calculation apparatus 28 calculates the rate of reduction of temperature of feed water supplied to reactor 1 to reduce the temperature of coolant at the inlet of the core 14 when the core flow rate increases in the end of the operation cycle.

The heat balance calculation apparatus 28 inputs the core flow rate calculated by the core flow rate control apparatus 26 (Step 28A). Instead of inputting the core flow rate from the core flow rate control apparatus 26, the heat balance calculation apparatus 28 can input the measured pressure difference from the differential pressure gauge 14 and calculate the core flow rate. The heat balance calculation apparatus 28 respectively inputs reactor pressure (steam pressure) measured by the pressure gauge 21, steam flow rate measured by the flow meter 22, steam temperature measured by the thermometer 23, feed water flow rate measured by the flow meter 24, and feed water temperature measured by the thermometer 25 (Step 28B). The heat balance calculation apparatus 28 calculates heat balance at Step 23C and calculate the temperature of feed water. Feed water temperature T is expressed by Formula (1).

W×h_{core}={(W−W_{feed})×hₛₐₜ(P)+W_{feed}×h(T, P)} (1)
where
h_{core}: Core inlet enthalpy
W: Core flow rate
W_{feed}: Feed water flow rate
hₛₐₜ: Enthalpy of saturation water (depending upon pressure)
P: Reactor pressure
T: Feed water temperature

By the way, h_{core} is calculated from T1=f (P1, h_{core}) where P1 is the pressure of the lower plenum 31 in reactor 1 and T1 is the temperature of cooling water in the inlet of the core. The lower plenum pressure P1 is corrected by adding hydrostatic head pressure of cooling water in the annular space 30 in reactor 1 and pressure increment by internal pump 12 to reactor pressure P. The lower plenum pressure P1 can be measured directly.

In formula (1),

(W−W_{feed})×hₛₐₜ(P) means amount of thermal energy of re-circulating cooling water (saturation) that is exhausted from the core 11 and is introduced into the annular space (down-comer) 30.

W_{feed}×h(T, P) means amount of thermal energy of feed water that comes into the annular space 30 from the outside of the reactor 1.

W×h_{core} means amount of heat of water that comes into the core 11.

Temperature T of feed water is calculated by Formula (1) that balances heat of feed water being supplied into the core 11, heat of re-circulating cooling water (saturation water) exhausted from the core 11 and introduced into the annular space 30, and heat of feed water being supplied into the reactor 1 from the outside.

Calculated feed water temperature T is output as a set feed water temperature (target feed water temperature) to the feed water temperature control apparatus 27. The feed water temperature control apparatus 27 controls the degree of the opening of steam flow rate controlling valve 17 so that the measured feed water temperature may reach the set feed water temperature according to feed water temperature T that is the set feed water temperature and the measured feed water temperature measured by the thermometer 25. In the present embodiment, since the heat balance calculation apparatus 28 calculates the feed water temperature T in the end of the operation cycle in which the core flow rate increases in most cases (for example, a period between 80% or later of one operating cycle and the shutdown of the reactor 1 to exchange the fuel assemblies in the operation cycle), the feed water temperature control apparatus 27 controls the feed water temperature in the end of the operation cycle by using feed water temperature T as the set temperature. The calculated feed water temperature T decreases as the core flow rate increases during the end of the operation cycle. Therefore, in the end of the operation cycle, the temperature of feed water being supplied to the reactor 1 decreases as the shutdown of the reactor 1 approaches. In the most period of the operation cycle before the end of the operation cycle, the feed water temperature control apparatus 27 controls the temperature of feed water by regulating the degree of the opening of steam flow rate controlling valve 17 so that the temperature of the cooling water becomes almost constant (the set feed water temperature) at the inlet of the core 11 as shown in FIG. 2. The present embodiment that controls the feed water temperature in the end of an operation cycle can reduce the temperature of the cooling water at the inlet of the core 11 in the end of the operation cycle as indicated by solid lines in FIG. 2 and increase the reactivity gain in the end of the operation cycle as already explained. The heat balance calculation apparatus 28 can start to calculate the feed water temperature T at a little time before the end of the operation cycle and the feed water temperature control apparatus 27 can use this feed water temperature T to control the temperature of the feed water.

In the present embodiment, although the heat balance calculation apparatus 28 calculates the feed water temperature T in the end of the operation cycle in which the core flow rate increases (for example, a period between 80% or later of one operation cycle and the shutdown of the reactor 1 to exchange the fuel assemblies in the operation cycle), it is possible to calculate the feed water temperature T throughout the whole operation cycle. In this example, the feed water temperature control apparatus 27 controls the feed water temperature by using the feed water temperature T calculated by the heat balance calculation apparatus 28 throughout the whole one operation cycle as a set feed water temperature. The calculated feed water temperature T decreases according to the increase of the core flow rate.

In general, the feed water heater heats the feed water by electric heaters or extracted steam. In the above embodiment, the feed water temperature is controlled by the adjustment of flow rate of the extracted steam based on regulation of the degree of the opening of steam flow rate controlling valve 17. The feed water temperature control apparatus 27 can also use electric heaters to control the feed water temperature according to feed water temperature T. In the control of the feed water temperature, it is possible to use both flow rate control of the extracted steam and control of heating amount of the electric heaters. Judging from the viewpoint of plant heat efficiency, the flow rate control of the extracted steam is preferable. However, the control of the heating amount of the electric heaters is more preferable judging from controllability to control the feed water temperature along with the change of the core flow rate.

Further, in general, control rod pattern change is carried out in an operation cycle. The reactivity of the core 11 is controlled with control rods based on the control rod pattern change. After the core flow rate and the thermal power of the core 11 are reduced, the control rod pattern change is carried out. After the control rod pattern change was carried out, the core flow rate is increased, and the thermal power of the core 11 is returned to the set power. This control rod pattern change is a particular operating mode. Therefore, the present embodiment does not perform the feed water temperature control based on the above-described feed water temperature T even when the core flow rate increases during the control rod pattern change.

The present embodiment performs the feed water temperature control only when the core flow rate is increased in the end of the operation cycle, by pay attention to the core flow rate change only. Therefore, the present embodiment is superior to the technologies of Japanese Patend Laid-open Nos. Hei 8(1996)-233989 and Sho 62(1987)-138794 since the present embodiment uses very few parameters to control the reactivity (only core flow rate as a parameter) and the control of the feed water temperature is easier. Furthermore, because of automatic feed water temperature control, the present embodiment is also superior in reducing operator's loads and risk of malfunction.

Although the present embodiment can be effectively applied to the existing nuclear power generation plant, the effect of the present embodiment will be striking when the present embodiment is applied to a nuclear power generation plant in which thermal energy being generated in fuel assemblies is increased in one operation cycle. In other words, when the rated power of reactor 1 is increased, thermal energy being generated in fuel assemblies will be increased in one operation cycle in the same one operation cycle period. This means that the nuclear fission rate must be increased in the core 11. Generally, when the reactor power is increased by less than 10%, the economical efficiency of fuel will not be reduced so much even when, in this case, the reactor power is increased by increase of uranium loading amount in fuel assemblies. The increase of the uranium loading amount in fuel assemblies can be obtained by optimal designing of core and fuel assemblies, optimizing (increasing) the diameter of each fuel rod and increasing the number of fuel rods from 9×9 fuel assembly in which a plurality of the fuel rods are arranged in 9 rows and 9 columns to 10×10 fuel assembly in which a plurality of the fuel rods are arranged in 10 rows and 10 columns. However, when the reactor power is increased by more than 10%, the enrichment of ²³⁵U must be increased in fuel assemblies and the economical efficiency of fuel reduces although the plant can increase the power by 10% or more. Therefore, the effect of the present embodiment is greater when it is applied to a nuclear power generation plant whose reactor power is made greater by 10% or more than the rated power at the time when the plant was constructed.

Further, since the power density of the core of the existing boiling water type nuclear power generation plant is about 50 kw/l, increasing the power dencity of the core by 10% or more is equivalent to increasing the power density over 55 kw/l. Similarly, increasing one operation cycle period by 10% or more is equivalent to increasing heat amount taken out from the core by 10% or more without exchanging fuel assemblies. Therefore this is almost equivalent to increasing thermal power of the core by 10% or more in the same period. Judging from this, since the normal one operation cycle is about 12 months, the core whose one operation cycle is 14 months or longer is approximately equal to core whose thermal power is increased by 10% or more in the same operation period.

A lot of thermal energy generated in a core in one operation cycle means a lot of fissile material amount consumed in one operation cycle. Accordingly, the number of new fuel assemblies to be loaded in the core increases before the operation cycle starts. Generally, a ratio of the number of fuel assemblies loaded in a core to the number of new fuel assemblies loaded to the core by fuel exchange is defined as a batch number. As the batch number becomes smaller, more thermal energy is taken out from fuel assemblies 1 in one operation cycle. When the power is increased greatly (10% or more) and the operating cycle is increased to about 24 months to improve the capacity factor of the plant, the batch number goes below 3. In such a core, the enrichment of fuel assemblies is increased to retain the reactivity. Therefore, a lot of burnable poisons must be used to control the reactivity and consequently, the economical efficiency of fuel reduces. The present embodiment that controls the temperature of cooling water at the inlet of the core can be obtained more effective when used for such a core.

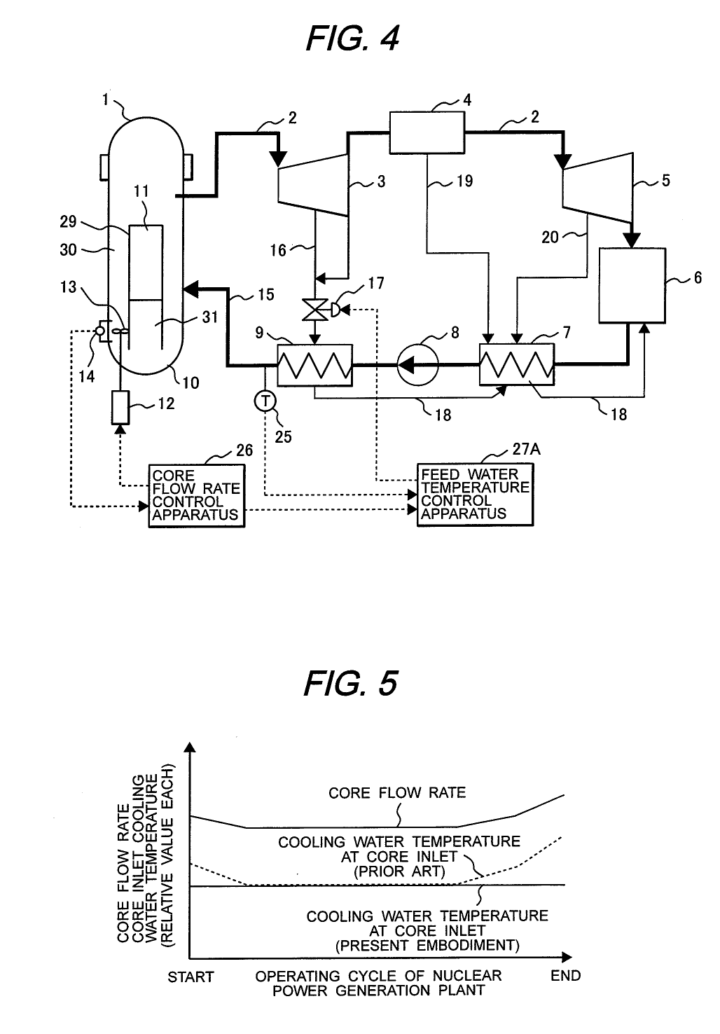

Referring to FIG. 4, below will be explained a boiling water type nuclear power generation plant which is another embodiment of the present invention. The nuclear power generation plant of the present embodiment is the same as the nuclear power generation plant shown in FIG. 1 except the heat balance calculation apparatus 28. In the aforesaid embodiment (see FIG. 1), the heat balance calculation apparatus 28 calculates the feed water temperature T while the plant is operating and the feed water temperature control apparatus 27 automatically controls the degree of the opening of steam flow rate controlling valve 17 according to the feed water temperature T to control the feed water temperature. Contrarily, the present embodiment calculates heat balance which is performed at the heat balance calculation apparatus 28 before starting respective operation cycle of the nuclear power generation plant, and obtains the feed water temperature (the set feed water temperature which is the feed water temperature T in the previous embodiment) that reduces along with the increase of the core flow rate in the end of the operation cycle. A plurality of calculated feed water temperature values (set feed water temperature values) are related respectively to the relevant core flow rates and stored in a memory of the feed water temperature control apparatus 27A in advance. The feed water temperature control apparatus 27A that inputs the calculated core flow rates by the flow rate control apparatus 26 controls the degree of the opening of steam flow rate controlling valve 17 based on the set feed water temperature value corresponding to the core flow rate and the feed water temperature measured by thermometer 25 so that the measured feed water temperature may become the set feed water temperature.

The present embodiment can obtain the same effect as the embodiment of FIG. 1. The present embodiment does not provide with the heat balance calculation apparatus 28 and simplify the configuration of the nuclear power generation plant.

Below will be explained a boiling water type nuclear power generation plant which is still another embodiment of the present invention.

In the boiling water type nuclear power generation plant of the present invention, a feed water temperature control apparatus 27A controls to keep the temperature of feed water constant in the end of one operation cycle in which the core flow rate increases as shown in FIG. 5. This control can be accomplished by causing the feed water temperature control apparatus 27A to keep the set feed water temperature constant in the end of the operation cycle. It is possible to increase the reactivity gain also by this feed water temperature control when the core flow rate increases in the end of the operation cycle although it is not so effective as to the embodiment of FIG. 1. Therefore, the economical efficiency of fuel of the plant can be improved in the same operation period. As explained above, the present embodiment can be accomplished by keeping the set feed water temperature constant in the end of the operation cycle in the boiling water type nuclear power generation plant of FIG. 4.

The present embodiment excels at automatic controlling of the temperature of cooling water at the inlet of the core 11 in the end of the operation cycle, which can reduce operators' loads and malfunctions. Furthermore, the present embodiment can facilitate evaluation for reactivity management of the core by controlling so as to keep the temperature of cooling water constant at the core inlet and is expected to improve the economical efficiency of plant operation and management.

The use of a system of the above embodiment can enable the following:

The feed water temperature control logic that increases the temperature of the cooling water at core inlet is assembled into the feed water temperature control apparatus 27A before the operation cycle starts. The use of the feed water temperature control logic can suppress the excessive reactivity by increasing the void fraction in the core during the operation cycle, consequently, reduce the reactivity operation by using control rods, and reduce the reactivity loss by the control rods. Accordingly, it is possible to increase the economical efficiency of fuel. In general, it is a period between the beginning of the operation cycle and the middle part of the operation cycle that the reactivity is excessive. Therefore, the control being used the feed water temperature control logic does not interfere with the control to reduce the feed water temperature in the end of the operation cycle even when the feed water temperature control logic is assembled in the feed water temperature control apparatus.

Further, it is possible to keep the thermal margin constant over the whole operating cycle by assembling another control logic into the feed water temperature control apparatus. The another control logic has functions that lowers the temperature of cooling water at the inlet of the core when the thermal margin (minimum critical power ratio) is small and increases the temperature of cooling water at the inlet of the core when the thermal margin (minimum critical power ratio) is large. The optimization of the thermal margin can cut off extra thermal margin and optimize fuel load patterns and so on. This can also improve the economical efficiency of fuel.

1. An operating method of a nuclear reactor, comprising steps of:
decreasing temperature of feed water supplied to a reactor when flow rate of coolant supplied to a core in said reactor which operates at set power in one operation cycle increases.

2. An operating method of a nuclear reactor, comprising steps of:
adjusting temperature of feed water supplied to a reactor so as to keep the temperature of coolant substantially set temperature at the inlet of the core when flow rate of coolant supplied to a core in said reactor which operates at set power in one operation cycle increases.

3. The operating method of the nuclear reactor according to claim 1 or 2, wherein the increase in the flow rate of the coolant is the increase in flow rate of the coolant in the end of the operation cycle.

4. The operating method of the nuclear reactor according to claim 1 or 2, wherein the set power is a rated power.

5. The operating method of the nuclear reactor according to claim 1 or 2, wherein the one operation cycle is 14 months or longer.

6. The operating method of the nuclear reactor according to claim 1 or 2, wherein the number of batches of the core is 3 or less.

7. The operating method of the nuclear reactor according to claim 1 or 2, wherein power density of the core is 55 KW/l or more.

8-11. (canceled)
